(19) United States
(12) Patent Application Publication
(10) Pub. No.: US 2018/0073528 A1
(43) Pub. Date: Mar. 15, 2018

(54) COMPACT SUPPORT CLAMP WITH SPRING ASSEMBLY

(71) Applicant: Pryor Products, Inc., Oceanside, CA (US)

(72) Inventors: Paul PRYOR, Fallbrook, CA (US); Richard Enoch Quintania, Fallbrook, CA (US); James Mark Cox, Winchester, CA (US)

(73) Assignee: Pryor Products, Inc., Oceanside, CA (US)

(21) Appl. No.: 15/427,529

(22) Filed: Feb. 8, 2017

Related U.S. Application Data
(60) Provisional application No. 62/393,974, filed on Sep. 13, 2016.

(51) Int. Cl. F16B 2/06; F16M 13/02; A61G 7/05; A61G 13/10

(52) U.S. Cl. CPC F16B 2/065; A61G 13/101; A61G 7/05; F16M 13/022

(57) ABSTRACT

A clamp for mounting a structure on a support. The clamp includes a fixed jaw, a base, and a moveable thruster plate between the fixed jaw and the base. The clamp includes a thruster cylinder configured to be rotateably received through the clamp body and having threads that engage a screw so that when the thruster cylinder rotates, the screw is advanced or retracted to move the thruster plate into and out of engagement with the support. A knob is used to rotate the thruster cylinder. The base includes an annular opening for storing a spring and receiving the screw and the thruster cylinder. The clamp is configured so that when the thruster plate engages the support, further axial movement of the screw is prevented and further rotation of the knob and thruster cylinder compresses the spring thereby causing the thruster plate to apply additional force to the support.

### CROSS REFERENCE TO RELATED APPLICATION

This application claims priority to and the benefit of U.S. Provisional Patent Application No. 62/393,974 filed Sep. 13, 2016. The foregoing provisional application is incorporated by reference herein in its entirety.

### BACKGROUND

In various applications structures such as equipment must be mounted from a support in proximity to the location where the equipment is utilized. This requirement is especially common with medical equipment that must be supported near where the equipment is utilized for medical treatment of patients.

Clamps with features for mounting equipment are known that are secured to existing supports such as tubular supports as in IV poles (vertical) and bed rails (horizontal). Clamps have also been utilized with planar supports such as table edges.

A typical clamp may comprise a c-clamp shape that grasps a support between a fixed jaw and a moveable jaw. The jaw operator mechanism for moving the moveable jaw into engagement with and securely grasping the support has typically utilized a screw carried in a threaded opening in the clamp body. This screw, of necessity, must be of a length greater than the maximum distance between the fixed and moveable jaws plus the width of the clamp body through which it is threaded. This creates an elongated profile that may interfere with other clamps or structures carried on the support.

Another feature which is desirable in equipment clamps is the ability to rotate attached equipment so that the equipment will be presented to the user in an upright orientation. In the past rotational capability has required substantial further protrusions from the clamp body to accommodate the rotational mechanism which further increases the profile of the clamp and the potential for interference with other clamps or structures on the support.

Various suggestions have been made that changes should be made to clamp designs including the suggestion of incorporating a lock to prevent removal of the clamp from the support on which the clamp is mounted and thereby to prevent removal of the device by unauthorized persons. It has also been suggested that it would be advantageous to reduce the overall width of the clamp by reducing the height of the structures used for rotation of the supported device. However, no structure to accomplish these objectives has been suggested.

Further, clamps in use today are tasked with supporting equipment of various weights. Versatile clamps that can support the heavy weights associated with today's medical equipment that are easy and convenient to use have not yet been developed.

The present applications discloses the deficiencies of conventional clamps and discloses various embodiments of clamps that include mechanisms that minimize the profile and provide additional versatility in light of the ever expanding size and weight of such equipment. Additionally, the disclosed clamps are not solely for equipment support. The disclosed clamps may be used for clamping structural elements together.

### SUMMARY

Locks on clamps for medical devices are part of the prior art, as are small diameter knobs, that can be used to advance or retract a threaded device rapidly when there is little or no resistance to the screws advance or retraction.

In an exemplary embodiment all advantages know to the applicant at the time of filing are incorporated. In a disclosed embodiment, a compact clamp and mount is provided for attaching equipment such as medical devices to a support. The clamp incorporates a moveable thruster plate which cooperates with a fixed jaw. The clamp is capable of mounting equipment from horizontal supports (such as a table edge or bed rail) and from vertical supports (such as an IV pole). Both cylindrical and flat supports are accommodated by shape of the thruster plate and fixed jaw.

After installation the equipment can be rotated on the clamp so that the equipment is in an upright orientation. In a modified embodiment dual rotational adjustment is accommodated for allowing an adjustment to device such as in the vertical plane, so that the equipment can be position in a way that both makes it easy for the user to observe, for example, controls and displays on the equipment and at the same time avoid interference with other equipment or structures that may be carried on the same support.

The clamp body incorporates all necessary functions in much less space than conventional clamps. The functions that may be accommodated include indexed rotation, clamp jaw or thruster plate advance and retraction without threaded extensions outside of the clamp body, and a lock to prevent unauthorized removal of the equipment from the support, and an indexed rotation wheel.

Indexed rotation is accomplished within the clamp body by incorporating a wheel recess with a central spindle about which the index wheel can rotate. The rotation of the wheel is controlled by a spring return trigger that retracts a tang from spaced index recesses in the periphery of the wheel to permit rotation to a selected indexed position. Nominal 90 degree spacing is shown. A mount plate is secured for rotation with the index wheel and incorporates an access opening to provide access to a bolt that is threaded into the central shaft. The equipment is carried on the mount plate.

The advance and retraction of the clamp jaw is accomplished through a thruster cylinder or barrel nut thruster cylinder that surrounds a threaded bolt attached to the thruster. As used herein, the terms thruster cylinder or barrel nut thruster cylinder are used interchangeably. An enlarged knob is attached to the cylinder which is threaded to engage the bolt near the outer end of the cylinder. The enlarged knob is sized to be easily grasped by the fingers and yet provide sufficient leverage to firm drive the thruster plate into engagement with a support. A left handed thread is provided so that clockwise rotation of the enlarged knob results in extension of the thruster plate to engage the support, which is what the user would intuitively expect from clockwise rotation.

The clamp body may optionally incorporate a lock to prevent substantial rotation of the enlarged knob and therefore prevent removal of the equipment from the support. A tubular cam lock is received in a cylindrical recess in the outer perimeter of the clamp body. A lock lever is mounted at the inner end of the lock body. When a key is rotated to the locked position the lock lever rotates to where it is adjacent to the thruster cylinder. The cylinder mounts a nub that extends from the cylinder so that the path of the nub intersects the position of the lock lever when the enlarged knob is rotated to the locked position and limits rotation of the cylinder to less than 360 degrees. This amount of rotation is not enough to disengage the clamp from cylindrical or square tubing supports.

In a further disclosed embodiment, two rotational elements are incorporated so that the position of the attached equipment can be varied to limit interference between multiple clamps attached to the same support. The second index plate is mounted in a recess in an arm which is in turn carried on the first index plate. The arm comprises an elongated plate and has sufficient thickness to incorporate the recess for the index plate which limits the offset of the associated mount plate from the clamp body.

Another embodiment of the clamp described herein further comprises an assembly for improving the load capacity of the clamp. This assembly may comprise one or more springs and flat washers housed within an annular space located adjacent to the end of a thruster cylinder or barrel nut thruster cylinder nearest the thruster plate. In such an embodiment, the thruster cylinder may have a lip or extended edge.

### BRIEF DESCRIPTION OF THE DRAWINGS

FIG. 1 is a perspective view of a clamp and mount with provisions for rotation about one axis.

FIG. 1A shows the clamp of FIG. 1, mounted on a wheeled IV stand and carrying a piece of equipment shown in dotted lines.

FIG. 2 is a perspective view of a clamp and mount with provision for rotation about two axes and a cylindrical lock.

FIG. 2A shows a two axis clamp mounting a piece of equipment (shown in dotted lines) on a wheeled IV stand.

FIG. 3 is a side view of FIG. 1 showing the provisions for attachment of the mount plate and access to the fastener that secures the rotational elements in a recess in the clamp body.

FIG. 4 is a sectional view taken along line 4-4 of FIG. 3 and showing the cylindrical thruster and recessed index wheel.

FIG. 5 is a top plan view of the clamp of FIG. 1.

FIG. 6 is a sectional view taken along line 6-6 of FIG. 5 and showing the trigger with associated tang engaging index openings of the index wheel.

FIG. 7 is a side view of the dual axis clamp of FIG. 2.

FIG. 8 is a sectional view taken along line 8-8 of FIG. 7 showing the lock cylinder being received in the clamp body outboard of the cylindrical thruster.

FIG. 9 is a top plan view of the clamp in FIG. 8.

FIG. 9A is a view identical to FIG. 9, except for the position of the section line utilized by FIG. 10.

FIG. 10 is a sectional view taken along line 10-10 of FIG. 9A and showing the elongated arm with index wheel at one end and provisions for mounting a mount plate at the other end.

FIG. 11 is a sectional view taken on line 11-11 in FIG. 9 and showing the second index wheel and trigger assembly.

FIG. 12 is a sectional view taken on line 12-12 in FIG. 9 and showing the lock cylinder and lock lever.

FIG. 13 is an end view of the clamp (52) to show the position of the detail view of the lock cylinder viewed from below.

FIG. 13A is a detail view of the engagement between the nub on the thruster cylinder, and showing the lock lever in position to engage the nub on the thruster cylinder.

FIG. 14 shows examples of wave springs that may be used in certain embodiments of the clamp described herein.

FIG. 15 is an image of an embodiment of the clamp comprising a spring as described herein.

FIG. 16 shows an embodiment of a thruster cylinder.

FIG. 17 is an image of the cross section of an assembly comprising a spring, flat washer, and a thruster cylinder.

FIG. 18 is an expanded view of a portion of the cross section of an assembly comprising a spring, flat washer, and a thruster cylinder shown in FIG. 17.

### DESCRIPTION

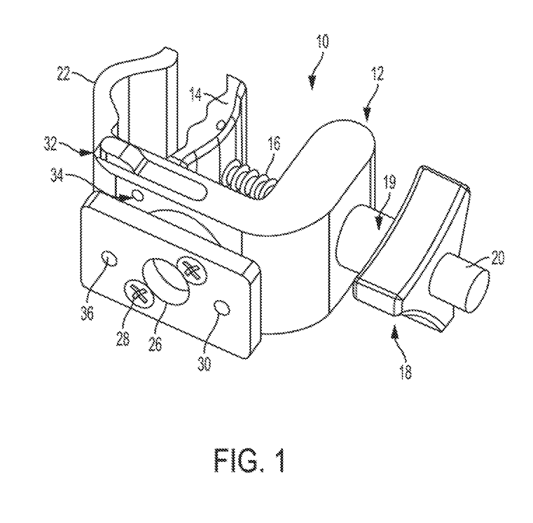

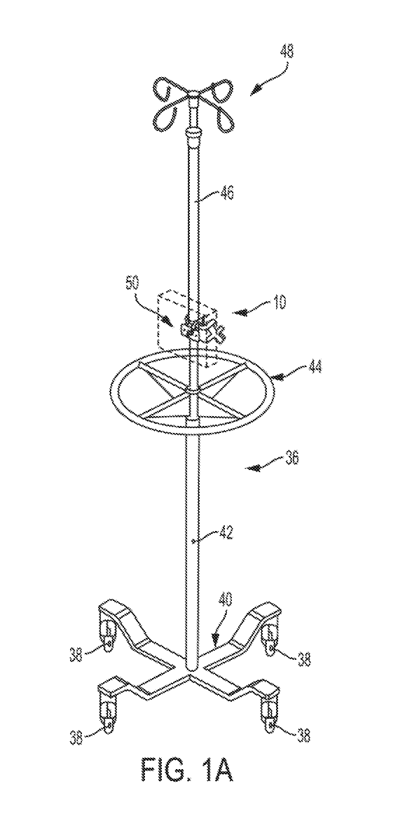

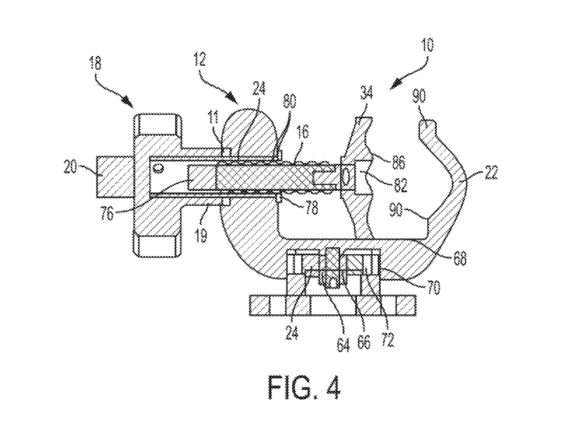

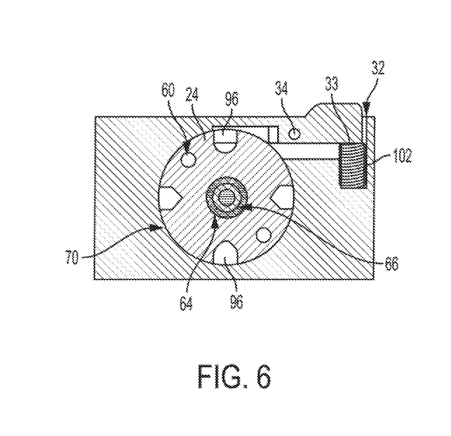

FIG. 1 shows the single rotational axis clamp (10) with a clamp body (12). The thruster plate (14) is attached to a screw (16) that is advanced/retracted by operation of the enlarged knob (18) which rotates the thruster cylinder (See FIG. 4). The thruster cylinder is in threaded engagement with the screw (16). The enlarged knob (18) has a knurled extension (20) for rapid rotation to bring the thruster plate (14) into engagement with a support (not shown) and to retract the thruster plate (14) after the tension on the support is released by use of the enlarged knob (18). The enlarged knob has a cylindrical extension (19) which surrounds the thruster cylinder and thereby provides room for the screw (16) to retract. The clamp (10) has a fixed jaw (22) opposed to the thruster plate (14). A mount plate (24) is secured to an index wheel (26) (See FIG. 4) by fasteners (28). The mount plate incorporates two mounting bores (30) through which fasteners can be passed to secure to a piece of equipment or other structure to the clamp (10). A trigger (32) is shown received in the clamp body (12) and carried on a pivot (34). The operation of the trigger (32) and index wheel (26) will be explained in greater detail by reference to FIG. 6.

The clamp body and associated parts are preferably formed of light-weight yet strong material. These materials may include metal (e.g., aluminum) and plastics (e.g., nylon).

FIG. 1A shows the clamp (10) mounted on a wheeled IV stand (36). The stand has wheels (38) on a base (40) with a vertical support (42) mounting a support wheel (44) (for use by ambulatory patients). The vertical support (42) carries a vertical IV pole (46) topped by an adjustable IV tree (48). A piece of equipment (50) is shown in dotted lines. The equipment may be an IV pump, heart monitor or other instrument or structure requiring support.

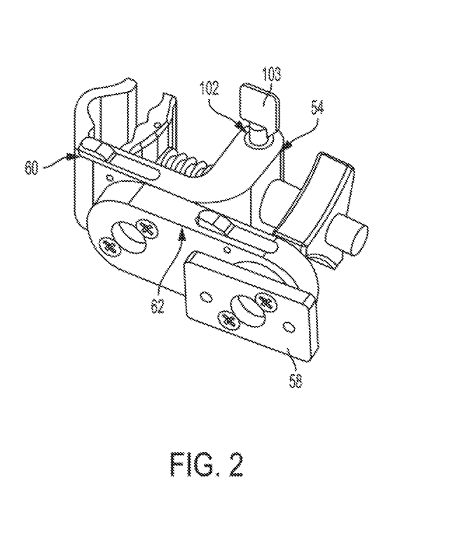

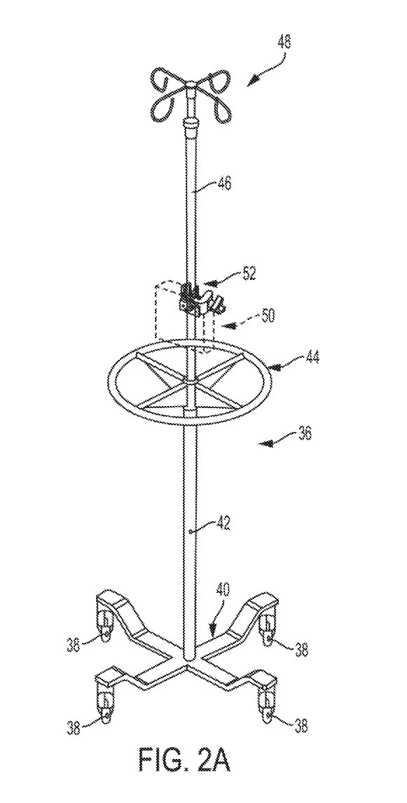

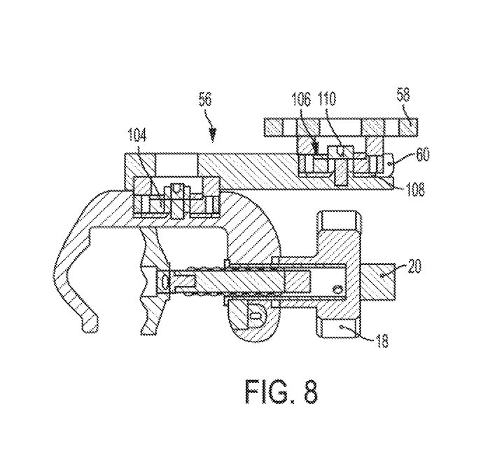

FIG. 2 shows a two axis clamp (52) having a clamp body (54). An elongated arm (56) provides an offset for the mount plate (58) which is in turn carried on an index wheel mounted in a recess (60) (See FIG. 8) in the elongated arm (56). Two triggers are provided to control rotation. Trigger (60) controls rotation of the arm (56) on the clamp body (54) and trigger (62) controls rotation of the mount plate (58) on the arm (56). By use of the trigger (60) a mounted structure such as a piece of medical equipment mounted on a vertical support (as in FIG. 2A) can be displaced horizontally by double the distance between the axes of the two index plates (See FIG. 8) by depressing the trigger (60) and rotating the arm (56) by 180 degrees. By comparing the position of the equipment (50) in FIG. 1A (single axis) to that in FIG. 2A (two axis with the elongated arm horizontal) it will be appreciated that the two axis embodiment can be used to vary the location of the equipment relative to the support (IV pole 36 in the illustrated examples).

Referring again to FIG. 2, the second trigger (62) controls the rotational orientation of the equipment. For example, if the arm (56) is rotated 90 degrees to the left to a vertical orientation it will displace the attached equipment upwardly. The second trigger (62) is then operated to permit rotation of the displaced equipment to the left to return it to an upright orientation. It will be apparent that the two axis configuration can be used in a similar manner when the clamp is carried on a horizontal support with the first rotation of the taking the arm to the horizontal to one side or the other and the rotation of the mount plate again being used to return the equipment to an upright orientation.

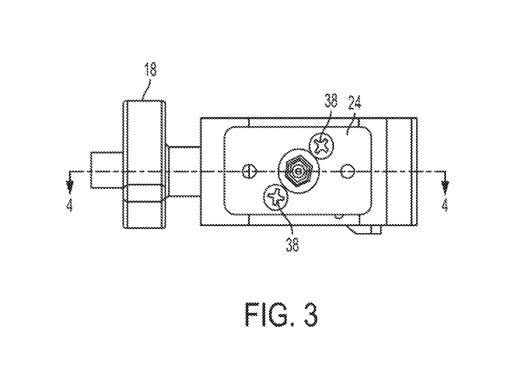

FIGS. 3 and 4 show the mount plate (24) in a single axis embodiment. The mount plate is attached to a threaded spindle (64) (See FIG. 4) by a fastener such as the insert nut (66). Screws (28) are threaded into the index wheel through threaded bores (68) (See FIG. 6). Accordingly the mount plate (24) rotates on the spindle (64) as determined by the indexed orientation of the index wheel (70). The arrangement of the spindle being located in a recess (72) within the clamp body (12) permits a minimal addition to the width of the clamp body to accommodate the rotation.

FIG. 4 shows the index wheel (70) journaled on the spindle (64) which is received in a cylinder (66) within the recess (72) that houses the index wheel (70). The spindle (64) is at right angles to the axis of the thruster cylinder. The enlarged knob (18) through the cylindrical extension (19) is shown as being secured to the thruster cylinder (74) by a pin (76). The pin (76) cooperates with the shoulder (78) on the thruster cylinder and the cylindrical extension (19) to capture the enlarged knob (18) and thruster cylinder (74) in the clamp body (12). Rotation of the enlarged knob (18) results in rotation of the thruster cylinder (74). The thruster cylinder is shown to have threads (80) at its terminal end which engage the screw (16). Thus the enlarged knob and cylinder rotate together and form a rotatable drive structure.

Rotation of the thruster cylinder (74) results in extension/retraction of the screw (16). The screw (16) does not rotate. It is through the use of the cylinder and screw combination that maximum length profile of the clamp (10) is reduced. The screw extends and retracts from within the cylinder and enlarged knob (18) so the enlarged knob (18) and does not move away from the clamp body (12) as in conventional designs increase the effective length as the jaw is retracted. The screw (16) is preferably configured with a left-hand thread. By using a left hand thread, clockwise rotation of the enlarged knob (18) results in the advance of the clamp jaw as a user would intuitively expect and avoids the confusion that would result if a right hand thread were employed.

Because the screw does not rotate the terminus (82) of the screw can be locked onto the jaw (14). The thruster plate (14) will preferably be in the form of a waffle plate (86) with ridges (84) that allow the jaw to securely engage a variety of surfaces on a support such as the IV pole in FIGS. 1A and 2A or to horizontal bars or planar horizontal surfaces. The waffle plate (86) is guided by engagement with the face (88) of the clamp body. The face (88) is flat so there is no tendency for the waffle plate to twist when it is extended toward the fixed jaw (22). The flats (90) on the fixed jaw (22) are useful for providing a substantial flat area for engaging planar surfaces.

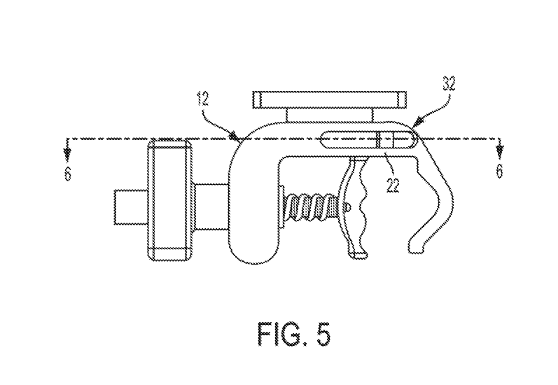

FIG. 5 shows the location of the trigger (32) within the closed side (92) of the clamp body (12).

FIG. 6 shows the trigger assembly (32) which includes the trigger lever (33) journaled on a pivot (34) and terminating in a tang (96) which is sized to fit into an index recess such as the exemplary recess (98) on the index wheel (70). The trigger tang (96) is held in engagement with an index recess (98) on the index wheel (70) by spring (100) so that the clamp will remain in a selected rotational orientation until the trigger (32) is depressed to withdraw the tang (96) free of the index recess (98). The index wheel (70) is shown to have threaded bores (68) which correspond to the openings in the mount plate (see FIG. 3).

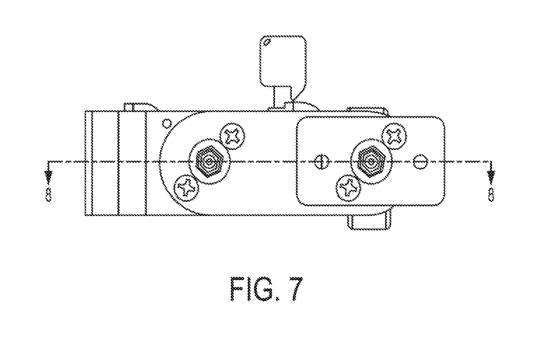

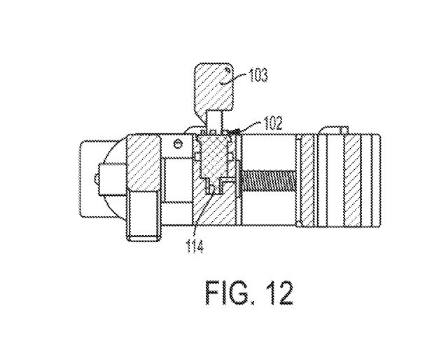

FIG. 7-13 shows the two axis embodiment of the clamp and also illustrates the use of a cylinder lock (102) (See FIG. 12) by utilization of the key (103) to prevent the removal of the clamp body (52) and thereby prevent the removal of the associated equipment.

FIG. 8 shows the first index wheel (104) mounts an elongated arm (56) instead of mounting the equipment directly as in the single axis version. The elongated arm (56) houses a second index wheel (106) with structure that duplicates the first index wheel except that the recess (108) which houses the second index wheel (106) is within the arm (56) instead of the clamp body (52). The recess (108) is at the end opposite to that attached to the clamp body. The use of a spindle (110) allows most of the structure for rotation to be housed within the body of the arm (56), rather than extending extensively beyond the surface of the arm. The result is a much lower width profile than can be achieved by conventional means. The mourning plate (58) in the two axis embodiment is offset from the axis of the index wheel (104) mounted in the clamp body (54) so that the mounted equipment may be positioned vertically above, below or the sides of that axis and thereby position to the equipment so that it does not interfere with other mourned equipment or structure on the support. As will appear the lock cylinder (102) is housed within the clamp body (54) and doesn't further enlarge the profile of the clamp when no key (103) is inserted.

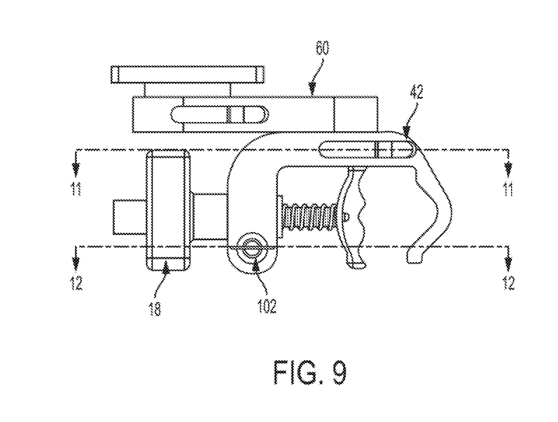

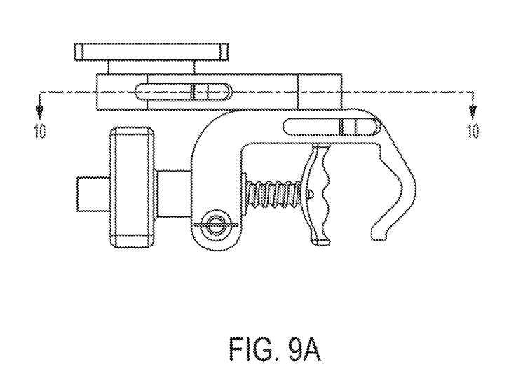

FIG. 9 is full line rendering of the device as in FIG. 8 showing the enlarged knob (18), the triggers (60) and (62).

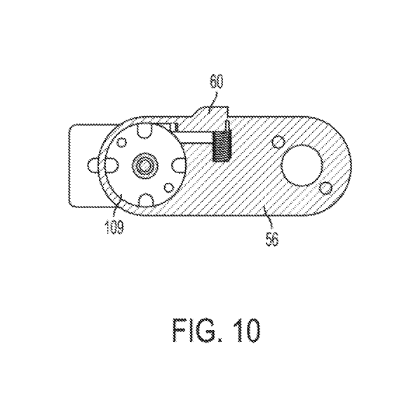

FIG. 9A is the same as FIG. 9 except that the section line 10-10 is placed so that the section view in FIG. 10 is positioned to show the index wheel (109) as is illustrated in FIG. 10.

FIG. 10 is a sectional view taken on line 10-10 of FIG. 9A and showing the index wheel (109) and trigger (60) as received for rotation within the elongated arm (56).

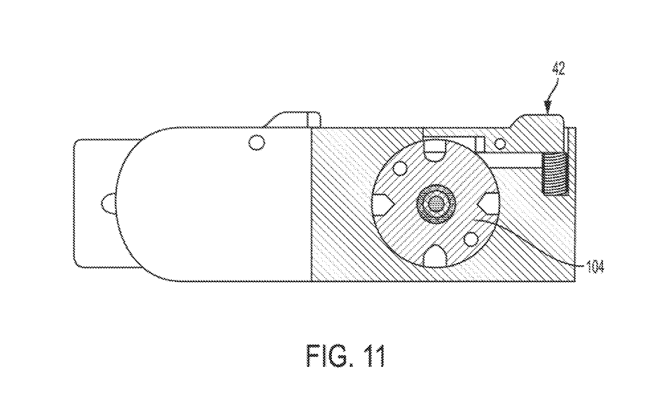

FIG. 11 shows index wheel (104) and the trigger (62).

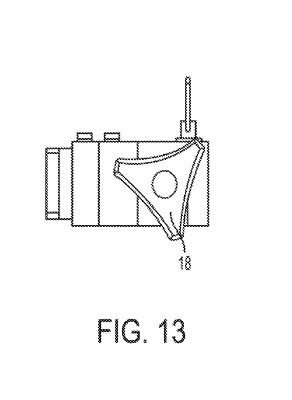

FIG. 12 shows the detail of a cylinder lock and key. The cylinder lock (102) has a lock lever (114) which is used to engage a nub (116) on the cylindrical extension (19) (see FIGS. 4 and 13A).

FIG. 13 shows the location 13 of the detail view in FIG. 13 (detail). The detail is an enlarged view of the cylinder lock as seen from below FIG. 13. The nub (116) is attached to the cylindrical extension (19). The nub (116) engages the lock lever (114) as the Enlarged knob (18), cylindrical extension (19) and thruster cylinder (118) (collectively the rotatable drive structure) are rotated through less than 360 degrees. Since the rotatable drive structure cannot be rotated even a full turn it is not possible to remove the clamp from a cylindrical support because the thruster plate (118) (See FIGS. 2 and 8) cannot be made to clear the cylindrical support.

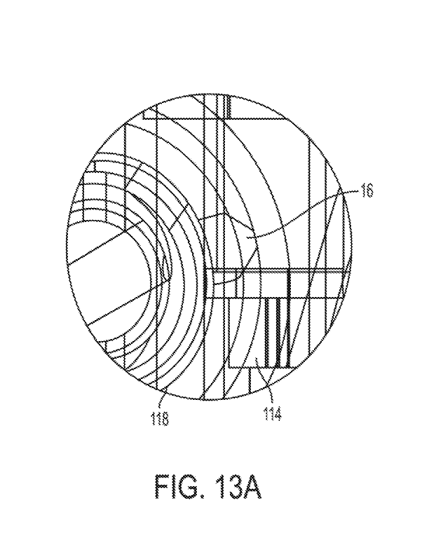

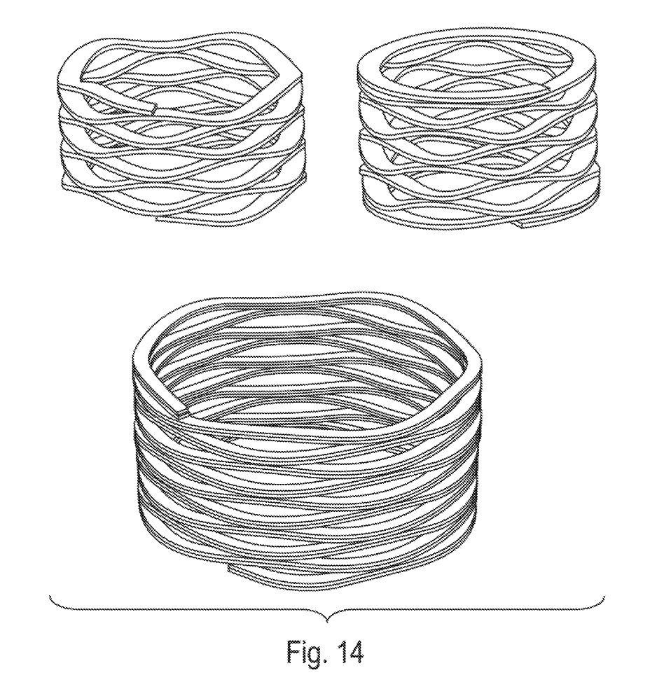

FIG. 15 shows an embodiment of a clamp as described above and further comprising an assembly for improving the load capacity of the clamp. This assembly may comprise one or more springs as well as one or more washers as well as a barrel nut thruster cylinder. The springs and washers are housed in an annular space within the fixed jaw of the clamp at the end of the barrel nut thruster cylinder adjacent to the thruster plate. Any of the known variety of springs may be used, including, but not limited to, wave springs, helical springs, linear springs, compression springs, and the like. For example, one or more of the wave type springs shown in FIG. 14 may be included.

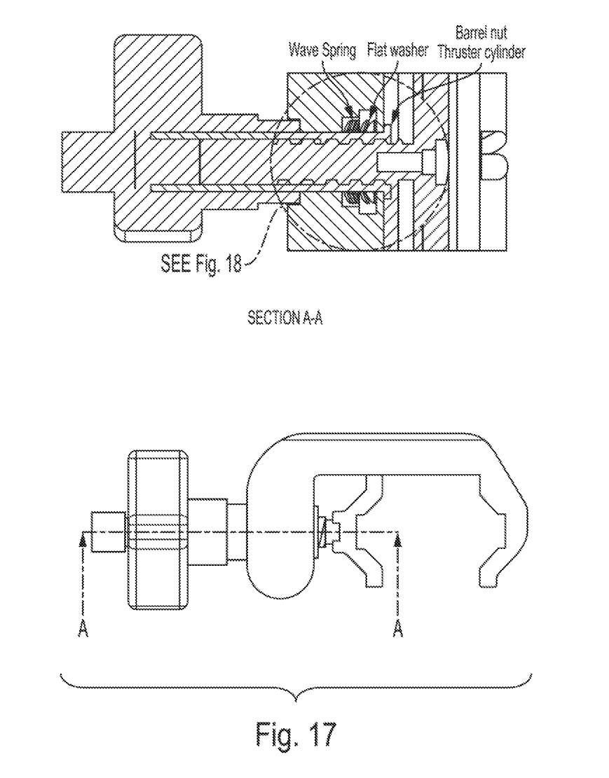

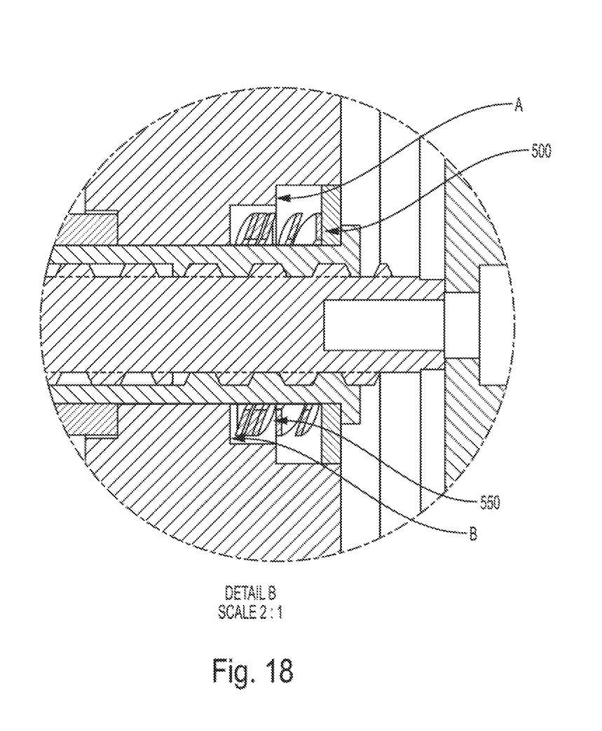

As seen in FIGS. 17 and 18, a disclosed embodiment of the clamp includes an assembly comprising a wave spring, a flat washer, and a barrel nut thruster cylinder having a lip or extended edge. As shown in FIG. 17, the fixed jaw of the clamp includes an annular space or opening for receiving the screw and the barrel nut. The annular opening may be machined into the fixed jaw of the clamp at the end of the barrel nut thruster cylinder nearest the thruster plate. This annular space allows for the placement of at least one wave spring in an orientation that provides load to the knob when the thruster plate has been extended and engaged. A flat washer is also provided as a contact surface between the wave spring and the surface of the lip of the barrel nut thruster cylinder. The spring may be configured to provide additional gripping force to support the medial equipment carried by the clamp. For example, a spring rated at approximately 30 lbs may be appropriate when the clamp is holding an IV pump weighing approximately 25-30 lbs.

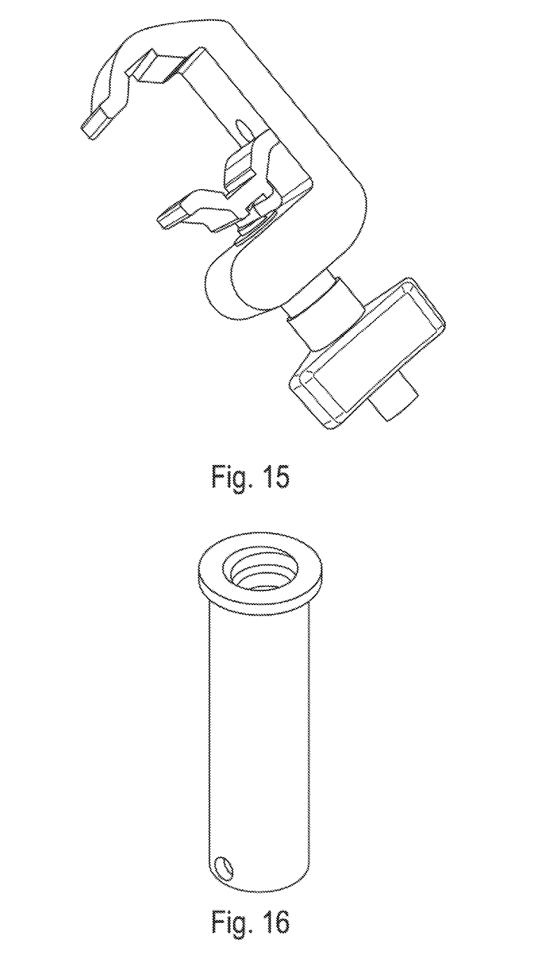

As with other embodiments of the disclosed clamp, advance and retraction of the thruster plate is accomplished through the barrel nut or thruster cylinder that surrounds a threaded bolt attached to the thruster plate. In the embodiment shown in FIGS. 14-18, the thruster cylinder or barrel nut includes a lip or extended edge. This lip or extended edge is in contact with the flat washer which itself is in contact with a wave spring. A knob is attached to the barrel nut thruster cylinder. A left handed thread is provided within the cylinder so that clockwise rotation of the knob results in axial movement of the bolt and corresponding movement of the thruster plate to engage a support.

In the embodiment shown in FIGS. 14-18, after the thruster plate has engaged the support, the knob may be further rotated. When the knob further rotates, the axial position of the bolt and the position of the thruster plate will not change because the thruster plate has engaged the support, but the thruster cylinder will continue to rotate to compress the wave spring via the flat washer. The knob may be rotated until the flat washer has engaged the surface of the annular opening in the fixed jaw of the clamp. The compressed spring provides additional force securing the thruster plate in position against the support so that inadvertent contact with the knob will not disengage the thruster plate from the support. A sufficient moment or torque must be applied to the knob to overcome the additional force being applied by the spring to the thruster plate. Thus, the provision of the spring provides a locking or securing function for the clamp. As a result, the disclosed clamp may support increased weight over similar clamps not provided with the spring biased clamping assembly herein disclosed. This assembly also provides a dampening effect to the knob when loosening the clamp thereby preventing the clamp from releasing too quickly.

As shown in FIG. 18, on the inner side of the fixed jaw of the claim the annular opening includes three regions of differing diameter or width. The narrowest width or diameter section is provided to accommodate the barrel nut or thruster cylinder. The largest diameter section is sized to accommodate the flat washer 500. The larger diameter section extends between a shelf or ledge A and the opening of the fixed jaw. The next section is sized to accommodate the wave spring 550, and has a diameter that is too short to accommodate the flat washer 500. The spring section of the annular opening includes a shelf or ledge B that prevents axial movement of the wave spring. When the thruster cylinder moves axially toward the knob after the thruster plate has engaged the support. The flat washer 500 moves with the lip of the thruster cylinder to thereby compress the spring 550. The movement of the thruster cylinder is limited by the flat washer 500 contacting the ledge surface A. As a result, the compressed axial length of the spring 550 is no less than the distance between the surfaces A and B. Thus, due to the limit on spring compression provided by the disclosed arrangement, the clamp provides for preventing failure of the spring due to excessive compression and/or cycles to allow for reliable and consistent operation of the clamp over time.

As shown in FIG. 18, on the exterior side of the fixed jaw of the clamp, the annular opening includes a widened section to accommodate a section of the knob that may optionally protrude into the fixed jaw. As shown in the figures, the threaded screw or bolt recedes into the knob when the thruster plate is withdrawn away from the support.

What is claimed:

1. A clamp for mounting and positioning a structure on a support comprising:
a clamp body having a C-shaped profile and including
a fixed jaw,
a base, and
a moveable thruster plate between the fixed jaw and the base, the thruster plate adapted to engage a support between the fixed jaw and the thruster plate; and
a thruster cylinder configured to be rotateably received through the clamp body, the thruster cylinder having threads that engage a screw such that when the thruster cylinder is rotated the screw is advanced or retracted to move the thruster plate into and out of engagement with the support between the fixed jaw and the thruster plate; and
a knob for rotating the thruster cylinder,
wherein
the base includes an annular opening storing a spring and is configured to receive the screw and the thruster cylinder, and
the clamp is configured so that when the thruster plate engages the support further axial movement of the screw is prevented and further rotation of the knob and thruster cylinder compresses the spring thereby causing the thruster plate to apply additional force to the support.

2. The clamp of claim 1, wherein
the base including the annular opening additionally stores a washer;
the thruster cylinder is a barrel nut having one of a lip and an extended edge, the washer being adjacent to a surface of the one of the lip and the extended edge; and
the clamp is configured so that when the thruster plate engages the support, the further rotation of the knob and the thruster cylinder causes the one of the lip and the extended edge of the thruster cylinder to apply a force to the washer to compress the spring until the washer engages a surface of the annular opening.

3. The clamp of claim 2, wherein the annular opening of the base comprises three sections including
a first section having a narrow diameter and configured to accommodate the thruster cylinder;
a second section having an intermediate diameter and configured to accommodate the spring, the second section including a first shelf to prevent axial movement of the spring; and
a third section having a wide diameter and configured to accommodate the washer, the third section including a second shelf and extending between the second shelf and the annular opening of the base, wherein
the further rotation of the knob and the thruster cylinder causes the washer to compress the spring until the washer engages the second shelf such that a compressed axial length of the spring is no less than a distance between the first shelf and the second shelf.

4. The clamp of claim 1, wherein the spring exerts a load against the knob when the thruster plate engages the support.

5. The clamp of claim 1, wherein the spring may be at least one of a wave spring, a helical spring, a linear spring and a compression spring.

6. The clamp of claim 1, wherein the annular opening is machined into the base of the clamp body.

7. The clamp of claim 1, wherein the clamp body comprises aluminum.

8. The clamp of claim 1, wherein the thruster plate comprises plastic.

9. The claim of claim 1, wherein the thruster cylinder recedes into the knob when the thruster plate retracts from the support.

10. A clamp for mounting and positioning a structure on a support comprising:
a clamp body having a C-shaped profile and including
a fixed jaw,
a base, and
a moveable thruster plate between the fixed jaw and the base, the thruster plate adapted to engage a support between the fixed jaw and the thruster plate; and
a thruster cylinder configured to be rotateably received through the clamp body, the thruster cylinder having threads that engage a screw such that when the cylinder is rotated the screw is advanced or retracted to move the thruster plate into and out of engagement with the support between the fixed jaw and the thruster plate,
wherein
the base includes an annular opening storing a spring and a washer and is configured to receive the screw and the thruster cylinder, the washer being adjacent to a surface of one of a lip and an extended edge of the thruster cylinder, and
the clamp is configured so that when the thruster plate engages the support further axial movement of the screw is prevented and further rotation of the thruster cylinder causes the one of the lip and the extended edge of the thruster cylinder to apply a force to the washer to compress the spring thereby causing the thruster plate to apply additional force to the support.

11. The clamp of claim 10, wherein
the thruster cylinder is a barrel nut; and
the clamp is configured so that when the thruster plate engages the support, the further rotation of the thruster cylinder causes the washer to compress the spring until the washer engages a surface of the annular opening.

12. The clamp of claim 11, wherein the annular opening of the base comprises three sections including
a first section having a narrow diameter and configured to accommodate the thruster cylinder;
a second section having an intermediate diameter and configured to accommodate the spring, the second section including a first shelf to prevent axial movement of the spring; and
a third section having a wide diameter and configured to accommodate the washer, the third section including a second shelf and extending between the second shelf and the annular opening of the base, wherein
the further rotation of the thruster cylinder causes the washer to compress the spring until the washer engages the second shelf such that a compressed axial length of the spring is no less than a distance between the first shelf and the second shelf

13. The clamp of claim 10, wherein
the spring exerts a load against the thruster cylinder when the thruster plate engages the support.

14. The clamp of claim 10, wherein an axial position of the screw and a position of the thruster plate remain unchanged when the thruster plate engages the support and the thruster cylinder is further rotated.

15. The clamp of claim 10, wherein the spring may be at least one of a wave spring, a helical spring, a linear spring and a compression spring.

16. The clamp of claim 10, wherein the annular opening is machined into the base of the clamp body.

17. The clamp of claim 10, wherein the clamp body comprises aluminum.

18. The clamp of claim 10, wherein the thruster plate comprises plastic.

19. A clamp for mounting and positioning a structure on a support comprising:
a clamp body having a C-shaped profile and including a
fixed jaw,
a base, and
a moveable thruster plate located between the fixed jaw and the base, the thruster plate adapted to engage a support between the fixed jaw and the thruster plate;
a thruster cylinder having a lip and configured to be rotateably received through the clamp body; and
a knob for rotating the thruster cylinder,
wherein
the base includes an annular opening storing a spring and a washer and is configured to receive the thruster cylinder, the thruster cylinder having threads that engage a screw such that when the cylinder is rotated the screw is advanced or retracted to move the thruster plate into and out of engagement with the support between the fixed jaw and the thruster plate, and
the clamp is configured so that when the thruster plate engages the support further axial movement of the screw is prevented, and further rotation of the knob and thruster cylinder causes the thruster cylinder lip to apply a force to the washer to compress the spring thereby causing the thruster plate to apply additional force to the support.
